(19) United States
(12) Patent Application Publication
(10) Pub. No.: US 2015/0027403 A1
(43) Pub. Date: Jan. 29, 2015

(54) METHOD AND DEVICE FOR CONTROLLING AN INTERNAL COMBUSTION ENGINE

(71) Applicant: ROBERT BOSCH GMBH, Stuttgard (DE)

(72) Inventors: Guido Porten, Wiernsheim (DE); Hans-Friedrich Schwarz, Muehlacker (DE); Peter Schenk, Ludwigsburg (DE)

(21) Appl. No.: 14/360,166

(22) PCT Filed: Nov. 12, 2012
(86) PCT No.: PCT/EP2012/072398

§ 371 Date: May 22, 2014

(30) Foreign Application Priority Data
Nov. 23, 2011 (DE) 10 2011 086948.4

(51) Int. Cl. F02D 19/02

(52) U.S. Cl. CPC F02D 19/024
USPC 123/299

(57) ABSTRACT

A method for starting an internal combustion engine in which fuel is injected directly into the combustion chamber using a multiple injection before an initial ignition of a fuel/air mixture, the fuel being injected directly into the combustion chamber during an intake stroke using a first injection and using a second multiple injection, the fuel being injected directly into the combustion chamber during a compression stroke.

### BACKGROUND OF THE INVENTION

1. FIELD OF THE INVENTION

The present invention relates to a method and a device for operating an internal combustion engine.

2. DESCRIPTION OF THE RELATED ART

Direct-injection gasoline engines work with injection pressures of up to 200 bar. Depending on the operating point, the pressure is adjusted in the range of 40 . . . 200 bar. To generate high pressure, systems may be used, for example, having a piston pump, driven mechanically by the internal combustion engine, a quantity control valve, and a high-pressure sensor. The delivery volume of the pump may in this case be changed by activating the quantity control valve. A control and/or regulating device controls the pressure to the desired level together with the measured high-pressure signal.

The activation of the injectors takes place on the basis of the measured pressure signal. A cold start of a direct-injection engine takes place either as a low-pressure start or as a high-pressure start. The advantages of a high-pressure start include a smaller injected fuel quantity required, less oil dilution, as well as fewer requirements for the design of the injectors (by reducing static flow rate Q_{STAT} and therefore greater accuracy in the case of small quantities).

The start of the internal combustion engine may take place according to different concepts:

For example, it is possible to carry out a single, double, or triple injection either during an intake stroke (360° to 180° crankshaft angle before ITDC) or during a compression stroke (180° to 0° crankshaft angle before ITDC).

It is also possible to divide up a double or a triple injection during the intake stroke and the compression stroke, or to carry out two injections during the compression stroke in the case of the triple injection.

If the internal combustion engine is designed in such a way that the injector has a central installation position, it is furthermore possible to additionally carry out a short injection close to the ignition timing.

It is furthermore possible to additionally carry out one or two pilot injection(s), each without ignition, during the stroke in question, partially at a low pressure or at a high pressure during the intake stroke.

In the case of a direct-injection system, a cold start poses high demands on the system. In the case of gasoline, this is true in the case of low temperatures; if ethanol is added as the propellant, the high demands occur already starting from 10° C. to 20° C. depending on the ethanol content. The background is that due to the poor mixture preparation at cold temperatures compared to the warm engine, an injection of significantly more fuel is necessary. This extra quantity may, for example, be enabled via an oversized high-pressure pump and/or via an oversized fuel rail. In order to improve the mixture preparation and/or to store the necessary fuel quantity in the fuel rail, it is furthermore possible to initially buildup an excessively high system pressure, which is reduced upon the beginning of the injection, until the high-pressure pump again covers the quantity needs of the engine. However, such a pressure buildup results in a prolonged start time, the worst case scenario being that a start of the internal combustion engine is noticed by the driver as being uncomfortable.

A method, in which the fuel pressure is detected and compared to a threshold value, for starting an internal combustion engine at low and pressures is known from published German patent application document DE 10 2004 046 628 A1. If the fuel pressure is below this threshold value, it is provided that the fuel injection is divided up between a plurality of injection pulses.

For applications in which fuel having a high ethanol content is used, such methods are not sufficient. In the case of special fuels, e.g., E85, an additional cold start valve maybe used, for example, which is complex and expensive. If E100 is used as the fuel, there is still no technical approach for the start at temperatures >5° C.

### BRIEF SUMMARY OF THE INVENTION

The present invention has the advantage over the related art that the starting ability of internal combustion engines is reliably possible at low temperatures even when fuels having a high ethanol content are used. For this reason, it is possible, for example, to design the used high-pressure pump in such a way that it has a smaller maximum delivery volume.

It has been found according to the present invention that it is particularly advantageous when, during a start, in particular during a high-pressure start, the fuel quantity to be injected is divided up into two phases, namely the intake stroke and the compression stroke. It has also been found according to the present invention that one or both of these injections may advantageously take place as multiple injections. A multiple injection is composed of a plurality of small partial injections, the number of the partial injections being selectable from 3 to 20.

Before the initial ignition of the fuel/air mixture, fuel is thus injected directly into the combustion chamber during the intake stroke using a first injection and fuel is injected directly into the combustion chamber during the compression stroke using a second multiple injection. Here, it is particularly advantageous for the mixture preparation when the first injection is carried out as a first multiple injection. Advantageously, the first multiple injection, the second multiple injection, and in particular the initial ignition are in this case in a cycle, i.e., the aforementioned compression stroke follows directly the aforementioned intake stroke, and the ignition takes place in the area of the ITDC which follows the aforementioned compression stroke. “In a cycle” therefore means that there is no exhaust stroke between the first injection and the second multiple injection on the one hand and the ignition on the other hand.

Furthermore, it is not absolutely necessary that the second multiple injection is completed during the compression stroke. It is merely necessary that the second multiple injection starts during the compression stroke. It is then indeed possible that the second multiple injection continues beyond the ITDC and into the combustion stroke which follows the compression stroke.

It is furthermore particularly advantageous when the last partial injection of the second multiple injections is close to, i.e., is separated by only a few degrees (e.g., less than 10°) of the crankshaft angle, the point in time of the in particular initial ignition, since on the one hand, the mixture preparation is improved due to the increased temperature in the combustion chamber as a result of the compression, and on the other hand, a rich charge layering forms close to the spark plug at the ignition timing. This improves the starting ability of the internal combustion engine.

It is also possible that the duration of the multiple injection overlaps chronologically with the ignition timing, i.e., the injection takes place during the ignition process, which also has a positive effect on the starting ability of the internal combustion engine.

Other advantages result when the fuel quantity necessary during the ignition of the fuel/air mixture is injected over multiple cycles, in particular when during the cycle which directly precedes the first multiple injection, fuel is injected during a first pilot injection, in particular during the intake stroke. This first pilot injection may, for example, be a high-pressure injection during which the high pressure is initially built up, for example, by cranking the engine in the case of a high-pressure pump which is driven mechanically by the internal combustion engine.

Such a pilot injection in particular results in the advantage that the design of the fuel system is simplified with regard to the delivery volumina and rail volumina due to the fact that the fuel quantity is introduced during multiple cycles, i.e., combustion cycles.

It has been found according to the present invention that such a pilot injection reduces the quantity of the fuel, which is to be injected using the multiple injections, so that the internal combustion engine reliably starts, although the fuel/air mixture is discharged uncombusted from the combustion chamber during a subsequent exhaust stroke. The fuel injected during the pilot injection ensures a wetting of the piston and the cylinder walls. Furthermore, depending on the geometry of the combustion chamber, the uncombusted fuel/air mixture is not discharged completely, and it is possible that a part of the uncombusted fuel/air mixture is sucked back in from the intake manifold or exhaust tract during the subsequent intake stroke.

If the fuel quantity injected during the pilot injection is selected in such a way that a saturated wall film is formed in the cylinder, the fuel quantity to be injected using the multiple injections may be reduced by this portion which is necessary for the wall film formation.

The fuel/air mixture, which is formed as a result of the fuel injection during the first pilot injection, is not ignited then, but only after additional fuel was injected during the first or the second multiple injection.

It is furthermore possible that the fuel quantity is also injected divided up over the course of a third cycle, in that during the cycle which directly precedes the first pilot injection fuel is injected using a second pilot injection, and the fuel/air mixture is not ignited during this cycle. The fuel/air mixture is thus only ignited during the cycle following the next cycle, namely during the ignition which follows the second multiple ignition. This second pilot injection may be, for example, carried out during an intake stroke.

Exemplary specific embodiments are illustrated in the following figures.

### BRIEF DESCRIPTION OF THE DRAWINGS

FIG. 1 schematically shows the design of a high-pressure injection system.

FIG. 2 schematically shows the injection and ignition points.

### DETAILED DESCRIPTION OF THE INVENTION

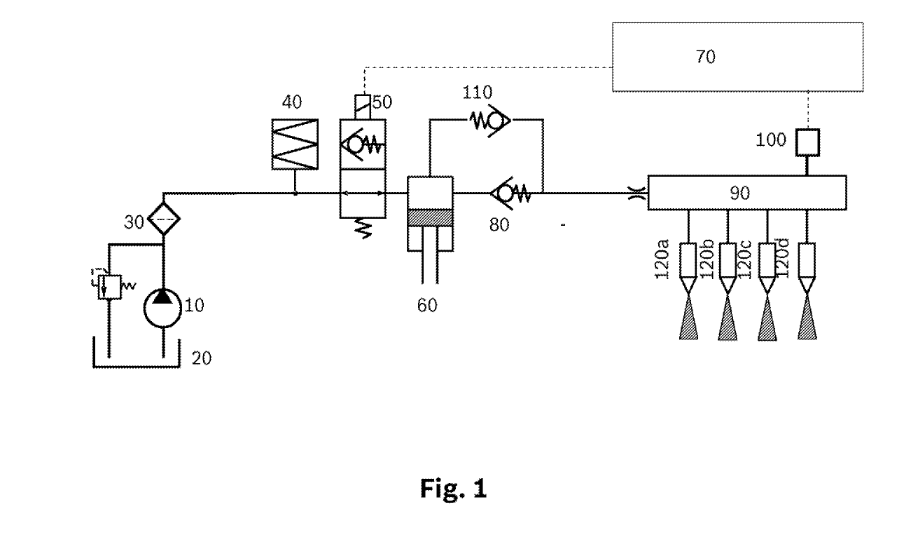

FIG. 1 shows an injection system. Fuel is pumped from a fuel tank 20 via a fuel filter 30, a low-pressure damper 40, and a quantity control valve 50 to a high-pressure pump using an electric fuel pump 10. Electric fuel pump 10, filter 30, low-pressure damper 40, and quantity control valve 50 form a low-pressure side of the injection system. The electric fuel pump generates a pressure of several bar, low-pressure damper 40 damps pressure pulsations in a fuel line in which the fuel is conveyed, and quantity control valve 50 is activated by a control and/or regulating device 70 in such a way that it meters the desired or necessary fuel quantity. High-pressure pump 60 conveys fuel to a fuel rail 90 via a check valve 80. High-pressure pump 60 generates a pressure of up to several 100 bar in the process. The pressure in high-pressure rail 90 is detected by a rail pressure sensor 100 and transmitted back to control and/or regulating device 70. The control and/or regulating device activates quantity control valve 50 accordingly as a function of this ascertained pressure in order to set the desired pressure. For safety reasons, a pressure limiting valve 110 is provided in order to delimit the pressure in the high-pressure rail.

Fuel from high-pressure rail 90 is injected into combustion chambers, which are not shown in FIG. 1, via high-pressure injectors 120a, 120b, 120c, and 120d which are also activated by control and/or regulating device 70. During one cycle, each one of these cylinders passes through the four strokes—intake stroke, compression stroke, combustion stroke, and exhaust stroke—in a manner known per se. The mechanical work generated is transferred to a crankshaft and a camshaft which may drive high-pressure pump 60. It is, however, also conceivable to tow-start high-pressure pump 60 by an electric machine.

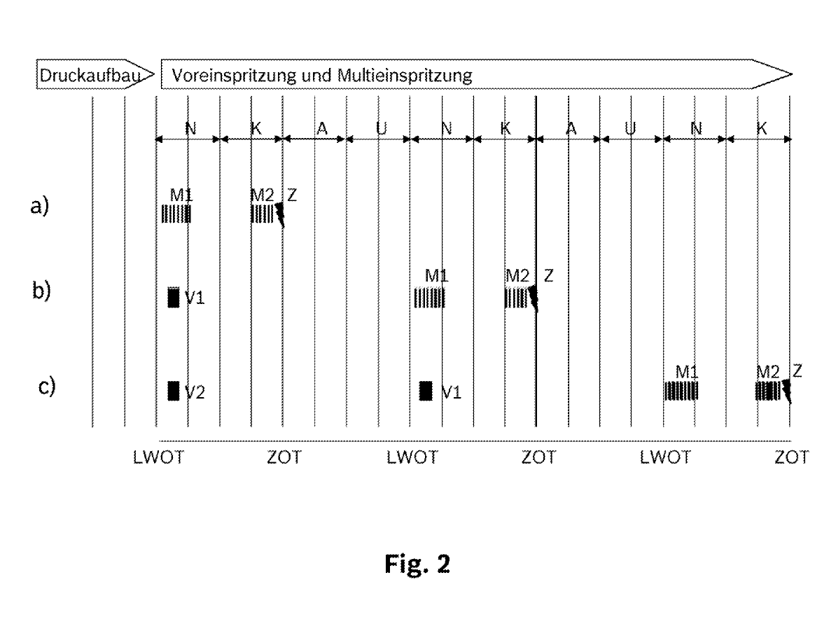

Injection and ignition points of the method according to the present invention for starting an internal combustion engine having an injection system according to FIG. 1 are illustrated in FIG. 2. The transition from exhaust stroke to intake stroke is referred to as LCTDC (load change top dead center), and the transition from compression stroke to combustion stroke is referred to as ITDC (ignition top dead center). The intake stroke is identified by reference symbol “N,” the compression stroke is identified by reference symbol “K,” the combustion stroke is identified by reference symbol “A,” and the exhaust stroke is identified by reference symbol “U” in FIG. 2.

FIG. 2a shows the injection points according to a first specific embodiment of the method according to the present invention in which a pilot injection is not carried out. During the intake stroke, which follows the LCTDC, fuel is injected using the first multiple injection. If at the beginning of the injection the angular position is indicated as usual as a crankshaft angle in degrees before ITDC, the LCTDC, which precedes the ITDC, has an angular position of 360° and the ITDC accordingly has an angular position of 0°. According to the specific embodiment according to the present invention, the injection start of first multiple injection M1 takes place during the intake stroke, advantageously in the range of 320° to 200° before ITDC, ideally at 240° before ITDC. The number of partial injections of first multiple injection M1 is in the range of 3 to 20, ideally 6. There is an interval time of 1 millisecond to 50 milliseconds, ideally 2 milliseconds, in each case between the individual partial injections of the first multiple injection. The quantity of injected fuel per partial injection is in the range of 1 milligram to 50 milligrams, ideally 10 milligrams. Instead of a first multiple injection, reference symbol M1 may, however, also identify a simple first injection or also a double injection.

These values are exemplary values of a direct-injection internal combustion engine having 1.4 liters displacement for starting at −30° C. and using pure gasoline as the fuel. In other internal combustion engines, other advantageous parameters may result.

In the exemplary embodiment of FIG. 2a, a second multiple injection M2 is furthermore carried out during the compression stroke. The parameters of second multiple injection M2 may be selected similarly to the values of first multiple injection M1, it obviously being necessary to select another angular position of the injection start. This angular position is advantageously 90° before ITDC. Directly before ITDC, the fuel/air mixture is ignited using an ignition Z during the compression stroke. As mentioned previously, it is also possible that the second multiple injection is such that it extends above and beyond the ITDC, i.e., that the injection end is in the combustion stroke which follows the compression stroke. It is in particular also possible that the angular position of ignition Z is between the angular positions of the injection start and the injection end of second multiple injection M2.

It is possible that, up to this first ignition Z, the internal combustion engine was tow-started with the aid of an electric machine and it now starts successfully with this first ignition Z, the other start operation being carried out in a conventional manner. It is, however, also possible that the above-described method is carried out as a direct-start method, i.e., without the tow-start by an electric machine. It is possible that these multiple injections are only used in one single cylinder of a multi-cylinder internal combustion engine and in all remaining cylinders, the fuel is injected in a conventional manner; it is, however, also possible that the described strategy having multiple injections M1 and M2 is used in some or all cylinders . The phase in which the multiple injections and the further start of the internal combustion engine are carried out is identified in FIG. 2 as “pilot injection and multiple injection.”

FIG. 2b shows a second specific embodiment of the present invention. Here, fuel is injected into combustion stroke N using a first pilot injection V1, preferably a high-pressure pilot injection. Preferably, this first pilot injection V1 is in the first half of intake stroke N. The cylinder now passes through compression stroke K, combustion stroke A, and exhaust stroke U in the further course of the cycle of first pilot injection V1, no ignition taking place in this cycle. After exceeding the LCTDC, the cylinder enters the next cycle in which, similarly to the exemplary embodiment illustrated in FIG. 2a, a first multiple injection M1 is carried out during intake stroke N and a second multiple injection M2 is carried out during compression stroke K, and an ignition takes place during compression stroke K.

m If first pilot injection V1 is carried out as a high-pressure injection, a high pressure is built up in fuel rail 90 using high-pressure pump 60 during a phase which is referred to in FIG. 2 as “pressure buildup,” before first pilot injection V1.

As in FIG. 2, it is possible that, up to this first ignition Z, the internal combustion engine was tow-started with the aid of an electric machine and it now starts successfully with this first ignition Z, the other start operation being carried out in a conventional manner. It is, however, also possible that the above-described method is carried out as a direct-start method, i.e., without the tow-start by an electric machine. In this case, it is necessary that high-pressure pump 60 is driven by an electric machine in order to build up high pressure in fuel rail 90.

It is possible that these multiple injections are only used in one single cylinder of a multi-cylinder internal combustion engine and in all remaining cylinders, the fuel is injected in a conventional manner; it is, however, also possible that the described strategy having pilot injection V1 and multiple injections M1 and M2 is used in some or all cylinders.

FIG. 2c shows a third specific embodiment of the present invention having two pilot injections which are preferably carried out as high-pressure pilot injections. During a combustion stroke N, a second pilot injection V2 is initially carried out similarly to first pilot injection V1 according to the exemplary embodiment of FIG. 2b. The internal combustion engine now passes through combustion stroke K, combustion stroke A, and exhaust stroke U, similarly to the exemplary embodiment in FIG. 2b, in order to enter, with the subsequent LCTDC, in intake stroke N of the following cycle. During this intake stroke, a first pilot injection V1 is now carried out similarly to FIG. 2b. An ignition does not take place in this cycle either, but only in the subsequent cycle. In this subsequent cycle, as in the specific embodiment illustrated in FIG. 2a and FIG. 2b, a first multiple injection M1 is carried out during intake stroke N and a second multiple injection M2 is carried out during compression stroke K before an ignition Z takes place.

If first pilot injection V1 is carried out as a high-pressure injection, a high pressure is built up in fuel rail 90 using high-pressure pump 60 during a phase which is referred to in FIG. 2 as “pressure buildup,” before first pilot injection V2.

As in FIG. 2, it is possible that, up to this first ignition Z, the internal combustion engine was tow-started with the aid of an electric machine and it now starts successfully with this first ignition Z, the other start operation being carried out in a conventional manner. It is, however, also possible that the above-described method is carried out as a direct-start method, i.e., without the tow-start by an electric machine. In this case, it is necessary that high-pressure pump 60 is driven by an electric machine in order to build up high pressure in fuel rail 90.

It is possible that these multiple injections are only used in one single cylinder of a multi-cylinder internal combustion engine and in all remaining cylinders, the fuel is injected in a conventional manner; it is, however, also possible that the described strategy having pilot injections V2 and V1 and multiple injections M1 and M2 is used in some or all cylinders.

1-12. (canceled)

13. A method for starting an internal combustion engine, comprising:
injecting fuel directly into a combustion chamber using multiple injections before an initial ignition of a fuel/air mixture;
wherein the fuel is injected directly into the combustion chamber during an intake stroke using a first injection, and the fuel is injected directly into the combustion chamber during a compression stroke using a second, multiple partial injections.

14. The method as recited in claim 13, wherein the first injection is implemented as first multiple partial injections.

15. The method as recited in claim 14, wherein the first multiple partial injections, the second multiple partial injections, and the ignition are in the same cycle.

16. The method as recited in claim 15, wherein the last partial injection of the second multiple partial injections is immediately before the ignition timing.

17. The method as recited in claim 15, wherein during the cycle immediately preceding the first multiple partial injections, fuel is injected using a first pilot injection and the fuel/air mixture is not ignited.

18. The method as recited in claim 17, wherein the first pilot injection is carried out during an intake stroke.

19. The method as recited in claim 17, wherein during the cycle immediately preceding the first pilot injection, fuel is injected using a second pilot injection and the fuel/air mixture is not ignited.

20. The method as recited in claim 19, wherein the second pilot injection is carried out during an intake stroke.

21. The method as recited in claim 17, wherein at least one of: (i) the first multiple partial injections include between 3 and 20 partial injections; and (ii) the second multiple partial injections include between 3 and 20 partial injections.

22. A non-transitory computer-readable data storage medium storing a computer program having program codes which, when executed on a computer, performs a method for starting an internal combustion engine, the method comprising:
injecting fuel directly into a combustion chamber using multiple injections before an initial ignition of a fuel/air mixture;
wherein the fuel is injected directly into the combustion chamber during an intake stroke using a first, multiple partial injections, and the fuel is injected directly into the combustion chamber during a compression stroke using a second, multiple partial injections.

23. A control device of an internal combustion engine, comprising:
means for controlling injection of fuel directly into a combustion chamber using multiple injections before an initial ignition of a fuel/air mixture;
wherein the fuel is injected directly into the combustion chamber during an intake stroke using a first, multiple partial injections, and the fuel is injected directly into the combustion chamber during a compression stroke using a second, multiple partial injections.
